(19) United States
(12) Patent Application Publication
(10) Pub. No.: US 2004/0210361 A1
(43) Pub. Date: Oct. 21, 2004

(54) Thermostat failure diagnosis method

(76) Inventor: Jung-Wook Na, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/750,689

(22) Filed: Dec. 31, 2003

(30) Foreign Application Priority Data
Apr. 16, 2003 (KR) 10-2003-0023999

(51) Int. Cl. G01M 17/00

(52) U.S. Cl. 701/29; 701/34

(57) ABSTRACT

A thermostat failure diagnosis method comprising the steps of: determining a standard time period in response to an intake air quantity and a cooling water temperature; counting down the standard time period until the standard time period reaches zero; detecting a cooling water temperature and storing same when the standard time period reaches zero; correcting a standard discriminating temperature with regard to the influence of intake air; and comparing the stored cooling water temperature with the corrected target temperature to determine whether or not a thermostat has failed.

### CROSS-REFERENCE TO RELATED APPLICATIONS

This application claims priority to Korean Application No. 10-2003-0023999, filed on Apr. 16, 2003, the disclosure of which is incorporated fully herein by reference.

### FIELD OF THE INVENTION

The present invention relates to a thermostat that controls the flow of cooling water to prevent overheating of the engine of a vehicle and, more particularly, to a thermostat failure diagnosis method adapted to avoid the misdiagnosis of a thermostat due to the presence of a head wind.

### BACKGROUND OF THE INVENTION

Generally, a thermostat is mounted between an engine and a radiator of a vehicle to promote cooling and prevent overheating of the engine. The thermostat is closed at an initial starting stage of the engine which quickly increases the cooling water temperature. When the cooling water temperature goes above a predetermined temperature, the thermostat automatically opens to circulate the cooled cooling water, thereby maintaining an appropriate engine temperature.

When an engine runs and the time it takes for the cooling water temperature to reach a predetermined temperature is longer than expected, the thermostat is diagnosed as failing.

There is a drawback in the thermostat failure diagnosis method thus described in that a misdiagnosis can occur from failing to consider a temperature increase restriction factor caused by a head wind when a vehicle is in motion. The head wind is a factor that has negative influence on the cooling water temperature increase vehicle speed increases, and the influence becomes fairly large as the outside air temperature decreases. Nevertheless, remedial actions are not taken to account for the head wind in conventional thermostat failure diagnosis methods. Another drawback is that a misdiagnosis relating to the failure of the thermostat is usually indicated by a warning lamp on the dashboard, which results in customer complaints and an increase in maintenance costs.

### SUMMARY OF THE INVENTION

The present invention provides a thermostat failure diagnosis method that accounts for the influence caused of a head wind to accurately determine whether a thermostat has failed.

The present invention further provides a thermostat failure diagnosis method that comprises the steps of: determining a standard time period based upon intake air quantity and the cooling water temperature; counting down from the standard time period to zero; detecting the cooling water temperature and storing same when the count down reaches zero; correcting an expected cooling water temperature by accounting for the influence of a head wind; and comparing the stored cooling water temperature with the corrected expected cooling water temperature to determine whether or not the thermostat has failed.

### BRIEF DESCRIPTION OF THE DRAWINGS

For a better understanding of the nature and objective of the present invention, reference should be made to the following detailed description with the accompanying drawings, in which:

FIG. 1 is a schematic block diagram illustrating a thermostat failure diagnosis method according to an embodiment of the present invention;

FIG. 2 is an operational flow chart of a thermostat failure diagnosis method according to an embodiment of the present invention; and

FIG. 3 is a map table for determining a correction constant in response to an average vehicle speed versus an intake temperature according to an embodiment of the present invention.

### DETAILED DESCRIPTION OF THE PREFERRED EMBODIMENT

The preferred embodiment of the present invention will now be described in detail with reference to the annexed drawings, where the present embodiment does not limit the scope of the present invention but is given only as an illustrative purpose.

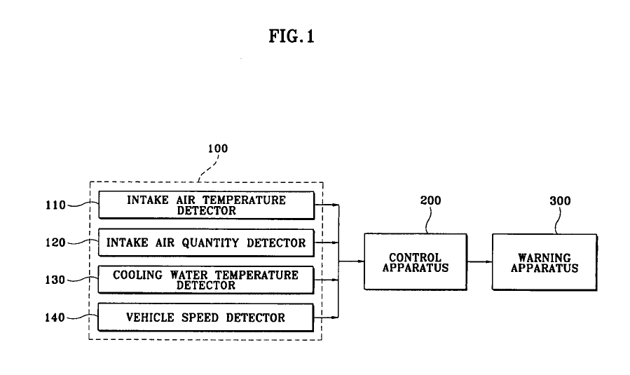

Referring to FIG. 1, a thermostat failure diagnosis apparatus comprises: a vehicle operation state detecting apparatus 100 that detects an intake air temperature, an intake air quantity, a cooling water temperature and a vehicle speed; an engine control apparatus 200 for receiving the intake air temperature, the intake air quantity, the cooling water temperature, and the vehicle speed for determining a correction response to a head wind during diagnosis of a thermostat failure for an accurate failure diagnosis, and for outputting a warning lamp lighting control signal when a failure occurs; and a warning apparatus 300 for lighting a warning lamp in response to the warning lamp lighting control signal outputted from the engine control apparatus 200 to request a driver to check the engine in response to the thermostat failure.

The vehicle operation state detecting apparatus 100 further includes an intake air temperature detector 110 for detecting the temperature of air sucked into an engine, an intake air quantity detector 120 for detecting the changes of intake air quantity sucked into the engine, an engine cooling water temperature detector 130 for detecting the changes of engine cooling water temperature, and a vehicle speed detector 140 for detecting a vehicle speed.

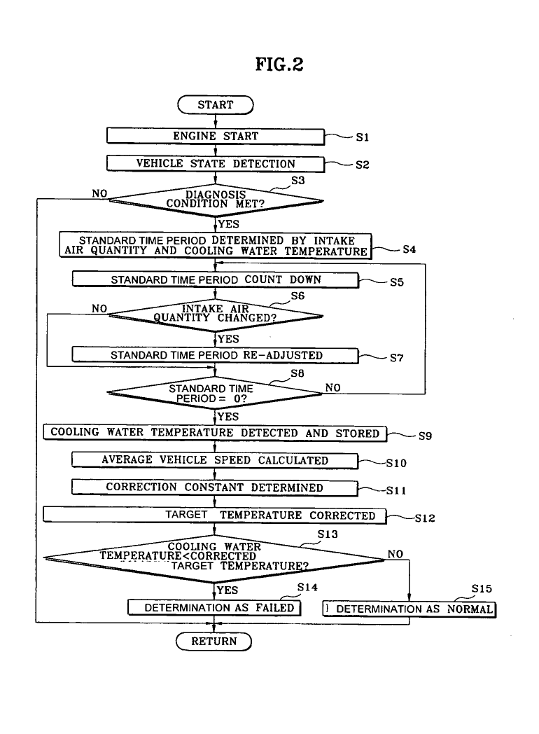

Referring to FIG. 2, when an engine is started, the vehicle operation state detecting apparatus 100 detects the intake air temperature, the intake air quantity, the cooling water temperature, the vehicle speed, and the like to input them to the engine control apparatus 200 (S1 and S2).

The control apparatus 200 then determines whether the information thus gathered meets a condition for diagnosing a failure of a thermostat (S3), and if the condition is met, the flow advances to carry out Step S4.

The thermostat failure diagnosis condition is previously defined using a cooling water temperature, an intake air temperature, and an intake air quantity during the start of the engine as factors, where the cooling water temperature during the start of the engine is within a prescribed range (e.g., between 7° C. and 77° C.), an absolute difference value between the cooling water temperature and the intake air temperature during the start of the engine is smaller than a prescribed temperature (e.g., 5° C.), and the intake air quantity is 5 g/sec or less and under 100 sec, or 48 g/sec or more and under 200 sec. The engine control apparatus 200 at Step S4 determines a standard time period in response to the intake air quantity and the cooling water temperature. If the quantity of air sucked into the engine is low, a standard time period (e.g., 2,000 steps) is set up in response to the cooling water temperature from a map table corresponding to the low air quantity. If the quantity of air sucked into the engine is intermediate, a standard time period (e.g., 1,800 steps) is established in response to the cooling water temperature from a map table corresponding to the intermediate air quantity. If the quantity of air taken into the engine is high, a standard time period (e.g., 1,600 steps) is set up in response to the cooling water temperature from a map table corresponding to the high air quantity. Countdown for the standard time period determined above begins (S5) at one step per 500 msec.

A determination is then made as to whether there is any change in the intake air quantity taken into the engine (S6), and if there is any change, the flow is advanced to carry out Step S7, and if there is no change, the flow proceeds to perform Step S8. At Step S7, the standard time period is re-adjusted. If an intake air quantity is changed from a low air quantity to an intermediate air quantity, a remaining time is determined in response to the countdown of the standard time period determined in the low air quantity domain and a standard time period is determined based upon the cooling water temperature measured when the intake air quantity is changed from the map table corresponding to the intermediate air quantity. A comparison is made between these two, and the standard time period having a larger value is determined as the new standard time period and a countdown is carried out.

At Step S8 it is determined whether the standard time period counted down has reached zero, and if the standard time period count down has not arrived at zero, the flow repeats performing Step S5 to continue the countdown operation. If the standard time period has reached zero, the flow proceeds to perform Step S9.

When the standard time period count down has reached zero, a cooling water temperature is detected at Step S9 and the cooling water temperature is stored in a memory. An average vehicle speed is then calculated for the time during which the standard time period was counting down (S10). At Step S11, a correction constant is determined taking into account the head wind. A map table is used to determine the correction constant that accounts for the intake air temperature during the start of the engine and the vehicle average speed calculated at Step S10. Then the correction constant is multiplied by a predetermined standard temperature to arrive at the target temperature (S12).

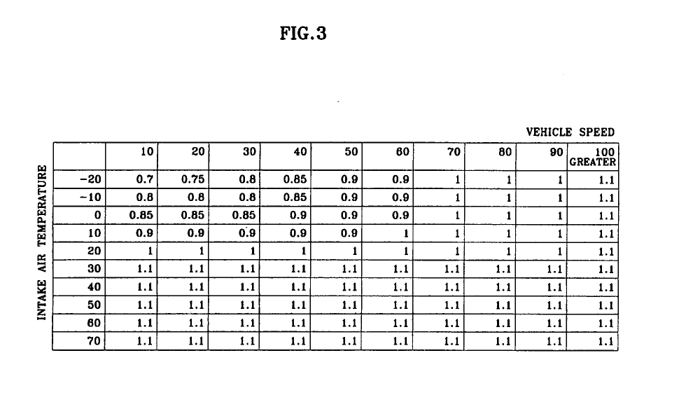

For example, if a target temperature is 77° C., an intake air temperature is 10° C., and an average vehicle speed is 50 km/h, then the correction constant is 0.9 (using a map table in FIG. 3, and the target temperature is multiplied by the correction constant to obtain a corrected temperature of 69.3° C. A comparison is made at Step S13 between the corrected target temperature and the cooling temperature detected and stored at S9. If the cooling temperature is lower than the corrected target temperature, the flow proceeds to carry out Step S14, and if the cooling temperature is above the corrected target temperature, the flow advances to perform Step S15.

At Step S14, the engine control apparatus 200 determines that the cooling water is continuously circulated due to a failure of the thermostat, and generates a thermostat failure code, storing the failure code in the memory and concurrently outputs to the driving apparatus 300 a warning lamp lighting signal. The driving apparatus 300 lights a warning light (not shown) mounted at a cluster so that the driver can check in response to the warning lamp output signal. At Step S15, however, the engine control apparatus 200 determines that the thermostat is working properly. For example, if the cooling water temperature detected and stored at Step S9 is 68° C., a corrected target temperature that accounts for the head wind is 69.3° C. The engine control apparatus 200 determines that a thermostat failure has occurred because the cooling water temperature is lower than the corrected target temperature.

The foregoing description of the preferred embodiment of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto, and their equivalents.

As apparent from the foregoing, there is an advantage in the thermostat failure diagnosis method thus described according to the embodiment of the present invention in that the thermostat failure diagnosis is reflected by a temperature rising restriction factor caused by a head wind to accurately determine whether or not a thermostat has failed and to enable to expand discrimination conditions as well, thereby improving failure determination to reduce erroneous failure determinations, failure repair costs and manufacturing costs.

There is another advantage in that no separate target temperature has to be established to enhance diagnosis performances even with the expansion of On-Board Diagnosis (OBD) restriction conditions in North America.

What is claimed is:

1. A thermostat failure diagnosis method comprising the steps of:
determining a standard time period in response to an intake air quantity and a cooling water temperature;
counting down until the standard time period reaches zero;
detecting a cooling water temperature and storing same when the standard time period reaches zero;
correcting a target temperature accounting for the influence of a head wind; and
comparing the stored cooling water temperature with the corrected target temperature to determine whether or not a thermostat has failed.

2. The method as defined in claim 1 further comprising a step of determining whether a thermostat failure diagnosis condition is met and carrying out the thermostat failure diagnosis only if the condition is met, wherein the thermostat failure diagnosis condition is previously defined using a cooling water temperature during the start of the engine, an intake air temperature during the start of the engine, and the intake air quantity as factors.

3. The method as defined in claim 1, wherein the countdown of the standard time period is performed by one step for every predetermined amount of time.

4. The method as defined in claim 1, wherein:
the step of determining the standard time period further comprises the step of determining the standard time period in response to the intake air quantity and cooling water temperature if the thermostat failure diagnosis condition is met; and
the step of counting down further comprises the step of re-adjusting the standard time period in response to the changed intake air quantity and the cooling water temperature thereof when the intake air quantity is changed during the countdown.

5. The method as defined in claim 4, wherein the standard time period re-adjusting step further comprises a step of comparing the standard time period remaining after countdown, just before the intake air quantity is changed, with a standard time period determined in response to the changed intake air quantity and cooling water temperature thereof to determine a larger time as a new standard time period and to continue the counting down step using the new standard time period.

6. The method as defined in claim 1, wherein the correcting step further comprises the steps of:
calculating an average vehicle speed;
determining a correction constant in response to intake air temperature and the average vehicle speed; and
multiplying the correction constant by the target temperature to determine the corrected target temperature.

7. The method as defined in claim 6, wherein the correction constant is stored in a map table such that the correction constant is based on the intake air temperature and the average vehicle speed.

8. The method as defined in claim 1, wherein the thermostat failure diagnosing step further comprises a step of determining that the thermostat has failed if the stored cooling water temperature is less than the corrected target temperature, and determining that the thermostat is functioning properly if the stored cooling water temperature is above the corrected target temperature.
